(19) United States
(12) Patent Application Publication
(10) Pub. No.: US 2026/0247123 A1
(43) Pub. Date: Aug. 20, 2026

(54) COMMUNICATION DEVICE, PROCESSING METHOD, AND STORAGE MEDIUM

(71) Applicant: SEIKO EPSON CORPORATION, Tokyo (JP)

(72) Inventor: Yohei OGAWA, Shiojiri (JP)

(21) Appl. No.: 19/540,829

(22) Filed: Feb. 16, 2026

(30) Foreign Application Priority Data
Feb. 17, 2025 (JP) 2025-023234

(51) Int. Cl. H04W 4/80

(52) U.S. Cl. CPC H04W 4/80

(57) ABSTRACT

A communication device according to the present disclosure includes a configuration processing unit configured to set, in a second external access point, wireless connection information registered in advance in the communication device, as information used for the communication device to establish a wireless communication connection with a first external access point, and a connection processing unit configured to establish a wireless communication connection with a second external access point using the wireless connection information.

The present application is based on, and claims priority from JP Application Serial Number 2025-023234, filed February 17, 2025, the disclosure of which is hereby incorporated by reference herein in its entirety.

### BACKGROUND

### Technical Field

The present disclosure relates to a communication device, a processing method, and a storage medium.

### Related Art

A technique for connecting a communication device to an external access point to construct a network such as a wireless local area network (LAN) is known. In order to establish a wireless communication connection between a communication device and an external access point, wireless connection information, such as a service set identifier (SSID) and a password, of the external access point needs to be registered in the communication device. In this regard, for example, JP-A-2011-188518 discloses a technique in which a user inputs an SSID and a password (network key) of an access point to a printer via a user interface screen displayed on a display unit of the printer.

In general, when an external access point that has been used so far is replaced with a new one due to occurrence of a failure or the like, wireless connection information for the new external access point needs to be registered in the communication device. However, it may be difficult for a user who is unfamiliar with registering the wireless connection information to configure again the wireless settings of the communication device based on the wireless connection information for the new external access point. For example, it is difficult for a user who has trouble even obtaining wireless connection information for the new external access point to configure again the wireless settings of the communication device. Therefore, there is a desire for a technique capable of easily establishing a wireless communication connection between a communication device and a new external access point.

### SUMMARY

According to an aspect of the present disclosure, a communication device includes: a configuration processing unit configured to set, in a second external access point, wireless connection information registered in advance in the communication device, as information used for the communication device to establish a wireless communication connection with a first external access point; and a connection processing unit configured to establish a wireless communication connection with the second external access point using the wireless connection information.

According to another aspect of the present disclosure, a processing method performed by a communication device includes: setting, in a second external access point, wireless connection information registered in advance in the communication device, as information used for the communication device to establish a wireless communication connection with a first external access point; and establishing a wireless communication connection with the second external access point using the wireless connection information.

According to another aspect of the present disclosure, a non-transitory computer-readable storage medium stores a program that causes a computer of a communication device to execute a process. The process includes setting, in a second external access point, wireless connection information registered in advance in the communication device, as information used for the communication device to establish a wireless communication connection with a first external access point; and establishing a wireless communication connection with the second external access point using the wireless connection information.

### BRIEF DESCRIPTION OF THE DRAWINGS

FIG. 1 is a schematic view illustrating an exemplary configuration of an information processing system including a communication device according to an embodiment.

FIG. 2 is a block diagram illustrating an exemplary configuration of the communication device according to the embodiment.

FIG. 3 is a block diagram illustrating an exemplary configuration of an external access point according to the embodiment.

FIG. 4 is a sequence chart illustrating a flow of operations in which, to provide wireless connection information to the external access point, the communication device establishes a wireless communication connection with the external access point.

FIG. 5 is a block diagram illustrating an exemplary configuration of a terminal device according to the embodiment.

FIG. 6 is a sequence chart illustrating the flow of operations in which the communication device establishes a wireless communication connection with an external access point when the communication device performs operations, as an Enrollee, defined in the Device Provisioning Protocol (DPP).

FIG. 7A is a flowchart illustrating an exemplary flow of detailed operations of the communication device according to the embodiment.

FIG. 7B is a flowchart illustrating the exemplary flow of detailed operations of the communication device according to the embodiment.

FIG. 8 is a block diagram illustrating an exemplary hardware configuration of a computer included in the communication device, the terminal device, or the external access point.

### DESCRIPTION OF EMBODIMENTS

Hereinafter, embodiments and the like will be described with reference to the figures. For clarity, certain description and figures may be omitted or simplified as appropriate. In each figure, identical elements are denoted by the same reference numerals, and redundant description is omitted where appropriate. In addition, not all of the features or steps illustrated in any one of the figures for describing an exemplary embodiment are necessarily indispensable, and some features or steps may be omitted. Furthermore, the order of the steps illustrated in any of the figures may be modified as appropriate.

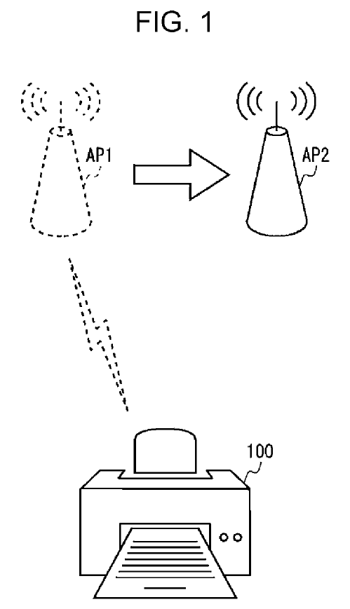

FIG. 1 is a schematic view illustrating an exemplary configuration of an information processing system 1 including a communication device 100 according to an embodiment. The information processing system 1 may include external access points AP1 and AP2. In addition, the information processing system 1 may include a terminal device 200 described later.

In the present embodiment, the external access point AP1 is to be replaced with the external access point AP2. The external access points AP1 and AP2 are, for example, LAN routers. The external access point AP1 is an access point with which the communication device 100 has already established a wireless communication connection. Therefore, in the present embodiment, the communication device 100 has already obtained wireless connection information for the external access point AP1. The external access point AP2 is a new access point. For example, default wireless connection information is set for the external access point AP2. In order for the communication device 100 to establish a wireless communication connection with the new external access point AP2, the communication device 100 needs to perform connection processing using the wireless connection information set for the external access point AP2.

The wireless connection information herein is information necessary for the communication device 100 to establish a wireless communication connection with an external access point, and specifically includes, for example, an SSID and a password of the external access point. However, the wireless connection information may be any information that is set in the access point and that is necessary for the communication device 100 to establish a wireless communication connection with the access point, and may include other information instead of or in addition to the SSID and the password. In addition, the wireless connection information may include only one of the SSID and the password.

In general, when the external access point AP1 used so far is replaced with a new external access point AP2, wireless connection information (for example, the default wireless connection information described above) for the new external access point AP2 needs to be registered (set) in the communication device 100. However, it is not easy for a user unfamiliar with registering wireless connection information to register wireless connection information for the new external access point AP2 in the communication device 100. That is, in some cases, it is not easy for the user to configure the wireless communication settings of the communication device 100.

Therefore, in the present embodiment, instead of registering the wireless connection information for the new external access point AP2 in the communication device 100, the wireless connection information for the existing external access point AP1 that the communication device 100 already has is set for the new external access point AP2. That is, the communication device 100 sets, in the external access point AP2, the wireless connection information of the external access point AP1 that the communication device 100 possesses as the wireless connection information of the external access point AP2. Thereby, the user need not obtain the wireless connection information of the external access point AP2 and manually register the obtained wireless connection information in the communication device 100. Hereinafter, a specific configuration and processing for implementing such processing will be described.

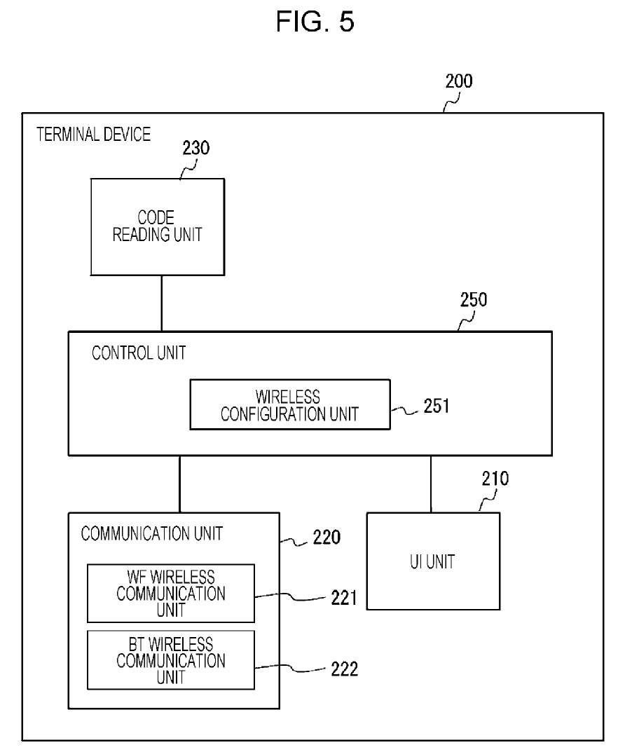

The Wi-Fi Alliance has established a technology known as Wi-Fi Easy Connect (registered trademark). This technology is a functionality in which a device called a Configurator provides wireless communication information to a device called an Enrollee in accordance with the DPP. In the present embodiment, in accordance with a process defined in the DPP, wireless connection information is transmitted from the communication device 100 to the external access point AP2, and the wireless connection information is set in the external access point AP2. In this case, the communication device 100 operates as a Configurator defined in the DPP, and the external access point AP2 operates as an Enrollee defined in the DPP. In the present embodiment, each of the communication device 100, the external access point AP2, and the terminal device 200 (see FIG. 5) is a device having a Wi-Fi Easy Connect capability.

In the present embodiment, the communication device 100 is a printer that prints information on media such as paper sheets. However, the communication device 100 may be any device having communication capabilities, and is not limited to a printer.

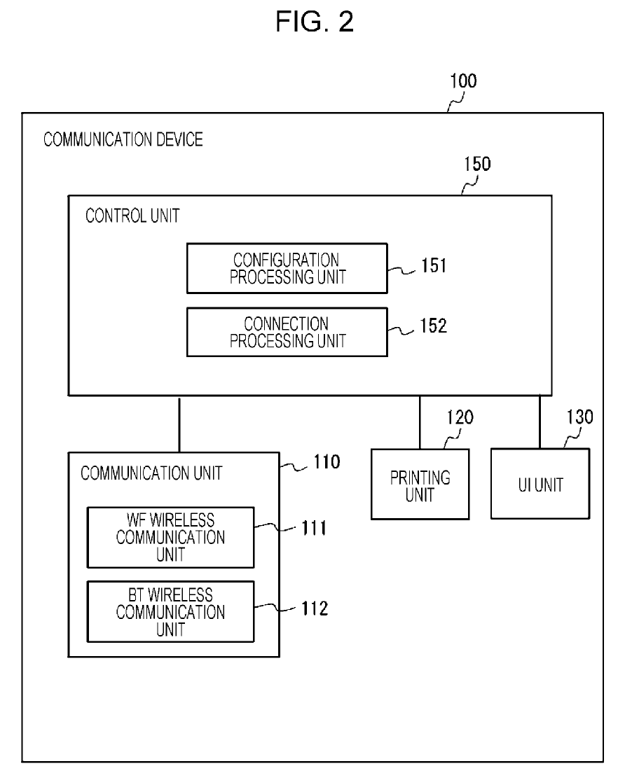

FIG. 2 is a block diagram illustrating an exemplary configuration of the communication device 100. As illustrated in FIG. 2, the communication device 100 includes a communication unit 110, a printing unit 120, a user interface (UI) unit 130, and a control unit 150.

The communication unit 110 is a hardware circuit that performs wireless communication with another device in accordance with a predetermined communication standard, and may include software such as firmware. The communication unit 110 includes a WF wireless communication unit 111 and a BT wireless communication unit 112.

The WF wireless communication unit 111 is a circuit that performs communication in accordance with a first wireless communication standard. That is, the WF wireless communication unit 111 transmits or receives information in accordance with the first wireless communication standard. In the present embodiment, specifically, the WF wireless communication unit 111 performs wireless communication in accordance with the Wi-Fi (registered trademark) standard.

The BT wireless communication unit 112 is a circuit that performs communication in accordance with a second wireless communication standard. That is, the BT wireless communication unit 112 transmits or receives information in accordance with the second wireless communication standard. In the present embodiment, the BT wireless communication unit 112 performs Bluetooth (registered trademark) communication, which is communication in accordance with a Bluetooth standard. More specifically, in the present embodiment, the BT wireless communication unit 112 performs wireless communication in accordance with a Bluetooth Low Energy (BLE) standard, which is a low-power consumption Bluetooth standard. When Bluetooth communication is unnecessary, the communication device 100 does not necessarily include the BT wireless communication unit 112.

The printing unit 120 includes a printing engine, which is a mechanical configuration that performs printing on media. In the present embodiment, the configuration of the printing unit 120 will be described as an ink jet printing configuration; however, the printing unit 120 may include a printing engine configured to perform printing using a coloring material (toner) by an electrophotographic printing method. In addition, the media is, for example, paper, but may be cloth or the like.

In the present embodiment, the printing unit 120 includes, as a printing engine, for example, a print head that ejects a coloring material onto media. The print head uses the supplied coloring material (specifically, ink) to perform ink jet printing. The printing engine may include, in addition to the print head, a media container that holds media, a transport mechanism that transports the media from the media container to a position facing the print head, a drive mechanism that drives a carriage including the print head, and the like. In this case, the printing unit 120 ejects the coloring material from the print head onto the media transported by the transport mechanism, thereby printing information such as an image on the media.

The UI unit 130 is a component that functions as a user interface. In the present embodiment, the UI unit 130 includes a display. The UI unit 130 may include an input device such as a button or a pointing device that receives an input operation from the user. The UI unit 130 may be implemented as a touch panel in which an input device and a display are integrally configured.

The control unit 150 controls the operation of the communication device 100. In particular, as illustrated in FIG. 2, the control unit 150 includes a configuration processing unit 151 and a connection processing unit 152, which function to establish a wireless communication connection between the external access point AP2 and the WF wireless communication unit 111.

The configuration processing unit 151 sets, in the external access point AP2, wireless connection information registered (set) in advance in the communication device 100, as information used for the communication device 100 to establish a wireless communication connection with the external access point AP1.

In addition, the connection processing unit 152 establishes a wireless communication connection with the external access point AP2 using the wireless connection information set in the external access point AP2, that is, the wireless connection information registered in the communication device 100 for establishing the wireless communication connection with the external access point AP1.

As described above, in the present embodiment, the wireless connection information is set in the external access point AP2 using the DPP (Wi-Fi Easy Connect). Accordingly, the configuration processing unit 151 sets the wireless connection information that the communication device 100 already has, in the external access point AP2, in accordance with a process defined in the DPP (Wi-Fi Easy Connect). In the DPP, the wireless connection information may be referred to as a Configuration Object.

In the DPP, processing for setting wireless connection information in the external access point AP2 includes three phases: bootstrapping, authentication, and configuration. As described above, when the communication device 100 sets the wireless connection information in the external access point AP2, the communication device 100 operates as a Configurator defined in the DPP, and the external access point AP2 operates as an Enrollee defined in the DPP.

Bootstrapping is a process in which the Enrollee provides predetermined information to the Configurator. The predetermined information is used in the subsequent authentication phase, and specifically includes a bootstrapping key defined in the DPP. The bootstrapping key is the public key of the Enrollee. The predetermined information may also be described as information that the Enrollee needs to provide to the Configurator to enable the Configurator to perform predetermined communication (communication in the authentication phase described later). Note that the predetermined information may include information such as a media access control (MAC) address of the Enrollee. Hereinafter, the predetermined information described above, which is provided from the Enrollee to the Configurator in the bootstrapping phase defined in the DPP, is also referred to as bootstrapping information.

Examples of methods for providing bootstrapping information in bootstrapping may include providing the bootstrapping information via communication in accordance with the Bluetooth standard and providing the bootstrapping information using a QR code (registered trademark). In the present embodiment, the external access point AP2, serving as the Enrollee, provides bootstrapping information to the communication device 100, serving as the Configurator, via BLE communication, as described later. In the authentication phase and the configuration phase, the Configurator and the Enrollee communicate with each other in accordance with the Wi-Fi standard.

Authentication is a process in which the Configurator and the Enrollee authenticate each other and generate a shared key to be used for encryption in transmission of the Configuration Object. That is, in this phase, a key for encrypting the wireless connection information is generated. Each of the Configurator and the Enrollee generates the shared key based on, for example, Elliptic Curve Diffie-Hellman key exchange (ECDH). In the authentication phase, first, the Configurator sends a signal called a DPP authentication request to the Enrollee. This signal includes a message generated using the bootstrapping information acquired from the Enrollee in the bootstrapping phase. Therefore, the bootstrapping information is information to be provided to the Configurator so that communication in accordance with a predetermined communication process (the DPP authentication request) with the Enrollee is started by the Configurator. In the authentication phase, after the DPP authentication request is transmitted, a signal called the DPP authentication response is transmitted from the Enrollee to the Configurator. Finally, a signal called a DPP authentication confirm is transmitted from the Configurator to the Enrollee.

Configuration is a process in which wireless connection information (Configuration Object) is transmitted from the Configurator to the Enrollee via encrypted communication using the shared key generated in the authentication phase. As a result, the wireless connection information used by the communication device 100 is set in the external access point AP2, which is the Enrollee. That is, the wireless connection information set in the external access point AP1 is also set in the external access point AP2. When default wireless connection information is set in the external access point AP2, the default wireless connection information is updated to the wireless connection information transmitted from the communication device 100. In the configuration phase, first, the Enrollee transmits a signal called a DPP configuration request to the Configurator. In response, the Configurator transmits a signal called a DPP configuration response to the Enrollee. The DPP configuration response includes wireless connection information (Configuration Object).

After the wireless connection information used by the communication device 100 is set in the external access point AP2, the connection processing unit 152 establishes a wireless communication connection with the external access point AP2 by performing a known connection establishment process using the wireless connection information. Specifically, the connection processing unit 152 performs a connection establishment process in accordance with the Wi-Fi standard. For example, the connection processing unit 152 performs processing for transmitting an association request signal to the external access point AP2 to request establishment of a wireless communication connection, and processing for performing four-way handshake communication with the external access point AP2. The connection processing unit 152 may perform a connection establishment process defined in the DPP.

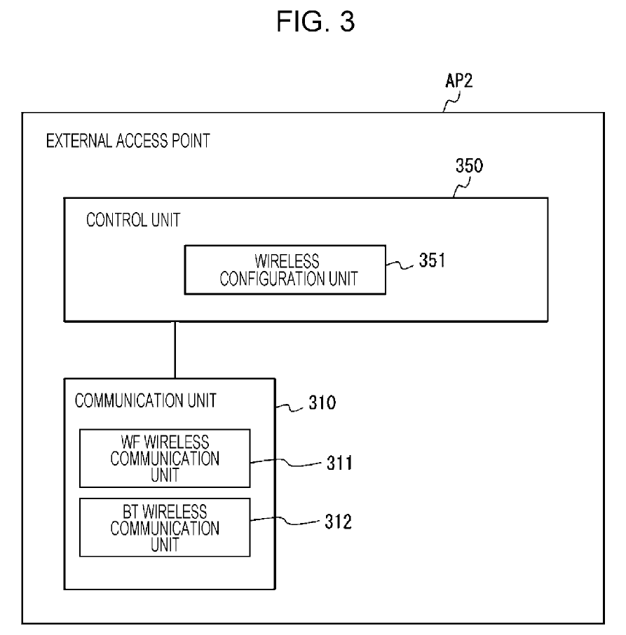

Next, the external access point AP2 will be described. In the present embodiment, the external access point AP2 can configure a LAN in accordance with the Wi-Fi standard in a manner similar to the external access point AP1. FIG. 3 is a block diagram illustrating an exemplary configuration of the external access point AP2. As illustrated in FIG. 3, the external access point AP2 includes a communication unit 310 and a control unit 350.

The communication unit 310 is a hardware circuit that performs wireless communication with another device in accordance with a predetermined communication standard, and may include software such as firmware. The communication unit 310 includes a WF wireless communication unit 311 and a BT wireless communication unit 312.

The WF wireless communication unit 311 is a circuit that performs communication in accordance with the first wireless communication standard described above. Specifically, the WF wireless communication unit 311 performs wireless communication in accordance with the Wi-Fi standard.

The BT wireless communication unit 312 is a circuit that performs communication in accordance with the second wireless communication standard described above. In the present embodiment, the BT wireless communication unit 312 performs Bluetooth communication, which is communication in accordance with the Bluetooth standard. More specifically, in the present embodiment, the BT wireless communication unit 312 performs wireless communication in accordance with the BLE standard. When Bluetooth communication is unnecessary, the external access point AP2 does not necessarily include the BT wireless communication unit 312.

The control unit 350 controls the operation of the external access point AP2. In particular, the control unit 350 includes a wireless configuration unit 351 for configuring wireless communication between the external access point AP2 and the communication device 100.

The wireless configuration unit 351 acquires wireless connection information from the communication device 100 in accordance with the process defined in the DPP described above, and sets the acquired wireless connection information as information used by the external access point AP2 and another device to establish a wireless communication connection. That is, the wireless configuration unit 351 performs processing as an Enrollee defined in the DPP. The wireless configuration unit 351 first performs processing in the bootstrapping phase, then performs processing in the authentication phase, and finally performs processing in the configuration phase. In the bootstrapping phase, specifically in the present embodiment, for example, the wireless configuration unit 351 causes the BT wireless communication unit 312 to transmit the bootstrapping information. That is, in this case, the BT wireless communication unit 312 transmits the bootstrapping information via BLE communication.

The wireless configuration unit 351 also performs processing for establishing a wireless communication connection with the communication device 100. Specifically, the wireless configuration unit 351 performs connection establishment processing with the communication device 100 in accordance with the Wi-Fi standard. For example, the wireless configuration unit 351 performs processing of transmitting an association response signal to the communication device 100, and processing for performing four-way handshake communication with the communication device 100. The wireless configuration unit 351 may perform connection establishment processing defined in the DPP.

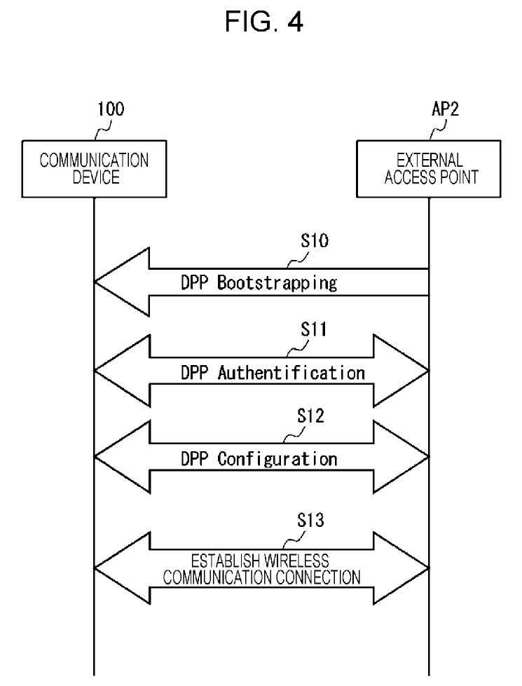

FIG. 4 is a sequence chart illustrating a flow of operations in which, to provide wireless connection information to the external access point AP2, the communication device 100 establishes a wireless communication connection with the external access point AP2. Hereinafter, the flow of the operations will be described with reference to FIG. 4.

In step S10, as described above, processing in the DPP bootstrapping phase is performed, and the bootstrapping information is provided from the external access point AP2 to the communication device 100.

In step S11, processing in the DPP authentication phase is performed between the communication device 100 and the external access point AP2. As a result, a key for transmitting the wireless connection information via encrypted communication is generated.

In step S12, processing in the DPP configuration phase is performed between the communication device 100 and the external access point AP2. As a result, the wireless connection information is transmitted from the communication device 100 to the external access point AP2 and is set in the external access point AP2.

Then, in step S13, using the wireless connection information described above, the communication device 100 establishes a wireless communication connection (that is, a wireless communication connection in accordance with the Wi-Fi standard) with the external access point AP2. In other words, in step S13, the communication device 100 uses the above-described wireless connection information to participate in the LAN using the external access point AP2.

As described above, in the present embodiment, the communication device 100 sets, in the external access point AP2, the wireless connection information of the external access point AP1 included in the communication device 100, as the wireless connection information of the external access point AP2. The communication device 100 then establishes a wireless communication connection with the external access point AP2 using the wireless connection information. Therefore, the user need not obtain the wireless connection information (for example, default wireless connection information) of the external access point AP2 or register the obtained wireless connection information in the communication device 100. Accordingly, a wireless communication connection can easily be established between the communication device 100 and the new external access point AP2, improving user convenience.

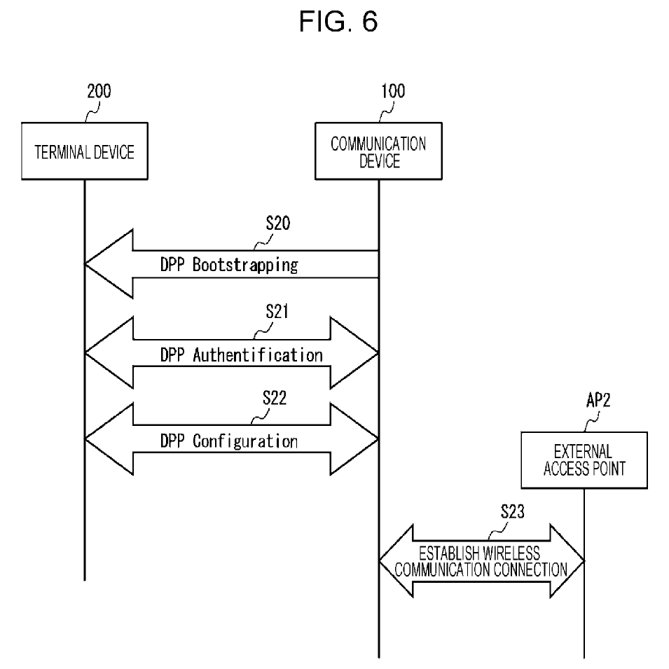

To implement the operations described above, the wireless connection information of the external access point AP1 needs to be registered (set) in the communication device 100, and the new external access point AP2 needs to operate as an Enrollee. However, there may be a case where the wireless connection information of the external access point AP1 is not registered (set) in the communication device 100, or a case where the new external access point AP2 does not operate as an Enrollee. Therefore, in the present embodiment, in such a case, the communication device 100 acquires the wireless connection information from the terminal device 200 that has the wireless connection information set in the external access point AP2, and establishes a wireless communication connection with the external access point AP2 using the acquired wireless connection information. This will be described in detail with reference to FIGS. 5 and 6.

FIG. 5 is a block diagram illustrating an exemplary configuration of the terminal device 200 that provides the wireless connection information of the external access point AP2 to the communication device 100. The terminal device 200 is a device that has already obtained wireless connection information for the external access point AP2. The terminal device 200 may be a device that has already established a wireless communication connection with the external access point AP2. In the present embodiment, the terminal device 200 transmits the wireless connection information set in the external access point AP2 to the communication device 100 in accordance with a process defined in the DPP. This enables the communication device 100 to establish a wireless communication connection with the external access point AP2. In this case, the terminal device 200 operates as the Configurator defined in the DPP, and the communication device 100 operates as the Enrollee defined in the DPP.

The terminal device 200 is, for example, a smartphone, a tablet terminal, a personal computer, or the like. As illustrated in FIG. 5, the terminal device 200 includes a UI unit 210, a communication unit 220, a code reading unit 230, and a control unit 250.

The UI unit 210 is a user interface device including an input device, such as a button or a pointing device that receives an input operation from the user, and a display. The UI unit 210 may be implemented as a touch panel in which an input device and a display are integrally configured.

The communication unit 220 is a hardware circuit that performs wireless communication with another device in accordance with a predetermined communication standard, and may include software such as firmware. The communication unit 220 includes a WF wireless communication unit 221 and a BT wireless communication unit 222.

The WF wireless communication unit 221 is a circuit that performs communication in accordance with the first wireless communication standard described above. Specifically, the WF wireless communication unit 221 performs wireless communication in accordance with the Wi-Fi standard.

The BT wireless communication unit 222 is a circuit that performs communication in accordance with the second wireless communication standard described above. In the present embodiment, the BT wireless communication unit 222 performs Bluetooth communication, which is communication in accordance with the Bluetooth standard. More specifically, in the present embodiment, the BT wireless communication unit 222 performs wireless communication in accordance with the BLE standard. Note that the terminal device 200 may not include the BT wireless communication unit 222 when Bluetooth communication need not be performed.

The code reading unit 230 is a reader that reads a code image such as a QR code. The code reading unit 230 may include a scanner or a camera as hardware for reading. The code reading unit 230 decodes the scanned or captured code image and reads information represented by the code image. Therefore, the code reading unit 230 can read the code image of the bootstrapping information of the communication device 100.

The control unit 250 controls the operation of the terminal device 200. In particular, the control unit 250 includes a wireless configuration unit 251 for configuring wireless settings of the communication device 100.

The wireless configuration unit 251 performs processing for assisting configuration of wireless settings in the communication device 100. In particular, the wireless configuration unit 251 performs predetermined processing for transmitting wireless connection information to the communication device 100. In the present embodiment, the wireless configuration unit 251 transmits the wireless connection information of the external access point AP2 held by the terminal device 200 to the communication device 100 in accordance with the process defined in the DPP. In the DPP, processing for transmitting wireless connection information from the Configurator (the terminal device 200) to the Enrollee (the communication device 100) also includes the three phases described above, bootstrapping, authentication, and configuration.

In response to the code reading unit 230 reading the code image including the bootstrapping information of the communication device 100 or in response to the BT wireless communication unit 222 receiving the bootstrapping information of the communication device 100, the wireless configuration unit 251 starts predetermined processing for transmitting wireless connection information to the communication device 100. That is, upon acquiring the bootstrapping information provided from the communication device 100, the wireless configuration unit 251 starts the processing in the DPP authentication phase. Thereafter, the wireless configuration unit 251 executes the processing in the DPP configuration phase, thereby transmitting wireless connection information to the communication device 100.

When the communication device 100 performs Enrollee-side operations defined in the DPP, the connection processing unit 152 of the communication device 100 performs the following processing. That is, when the wireless connection information for establishing a wireless communication connection with the external access point AP1 is not registered in the communication device 100, or when the external access point AP2 operating as an Enrollee cannot be found, the connection processing unit 152 causes the communication device 100 to operate as the Enrollee, and performs the following processing. In such a case, first, the connection processing unit 152 outputs predetermined information to be provided from the Enrollee to the Configurator in the bootstrapping phase defined in the DPP, that is, bootstrapping information. Next, from the terminal device 200 operating as the Configurator defined in the DPP and having acquired predetermined information (bootstrapping information), the connection processing unit 152 acquires wireless connection information for establishing a wireless communication connection with the external access point AP2, in accordance with the process defined in the DPP. Then, using the wireless connection information acquired from the terminal device 200, the connection processing unit 152 establishes a wireless communication connection with the external access point AP2.

As the processing of the bootstrapping phase, the connection processing unit 152 of the communication device 100 performs the following processing. For example, the connection processing unit 152 generates an image of a two-dimensional code such as a QR code in which the bootstrapping information of the communication device 100 is encoded. In this case, the connection processing unit 152 may cause the UI unit 130 to display a code image including the bootstrapping information, or may cause the printing unit 120 to print the code image. In this case, the code image is read by the code reading unit 230 of the terminal device 200. In addition, the connection processing unit 152 may transmit the bootstrapping information instead of or together with output of the code image. That is, the connection processing unit 152 may cause the BT wireless communication unit 112 to transmit the bootstrapping information of the communication device 100. In this case, the bootstrapping information is transmitted to the terminal device 200 via BLE communication.

FIG. 6 is a sequence chart illustrating a flow of operations in which the communication device 100 establishes a wireless communication connection with the external access point AP2 when the communication device 100 performs Enrollee-side operations defined in the DPP. Hereinafter, the flow of the operations will be described with reference to FIG. 6.

In step S20, processing in the DPP bootstrapping phase is performed, and the bootstrapping information is provided from the communication device 100 to the terminal device 200.

In step S21, processing in the DPP authentication phase is performed between the terminal device 200 and the communication device 100. As a result, a key is generated for transmitting, via encrypted communication, the wireless connection information of the external access point AP2 held by the terminal device 200.

In step S22, processing in the DPP configuration phase is performed between the terminal device 200 and the communication device 100. As a result, the wireless connection information is transmitted from the terminal device 200 to the communication device 100.

Then, in step S23, using the wireless connection information, the communication device 100 establishes a wireless communication connection (that is, a wireless communication connection in accordance with the Wi-Fi standard) with the external access point AP2. In other words, in step S23, the communication device 100 uses the wireless connection information acquired from the terminal device 200 to participate in the LAN using the external access point AP2.

In the present embodiment, an example will be described below in which the device operating as the Configurator is the terminal device 200; however, the device operating as the Configurator may instead be the external access point AP2.

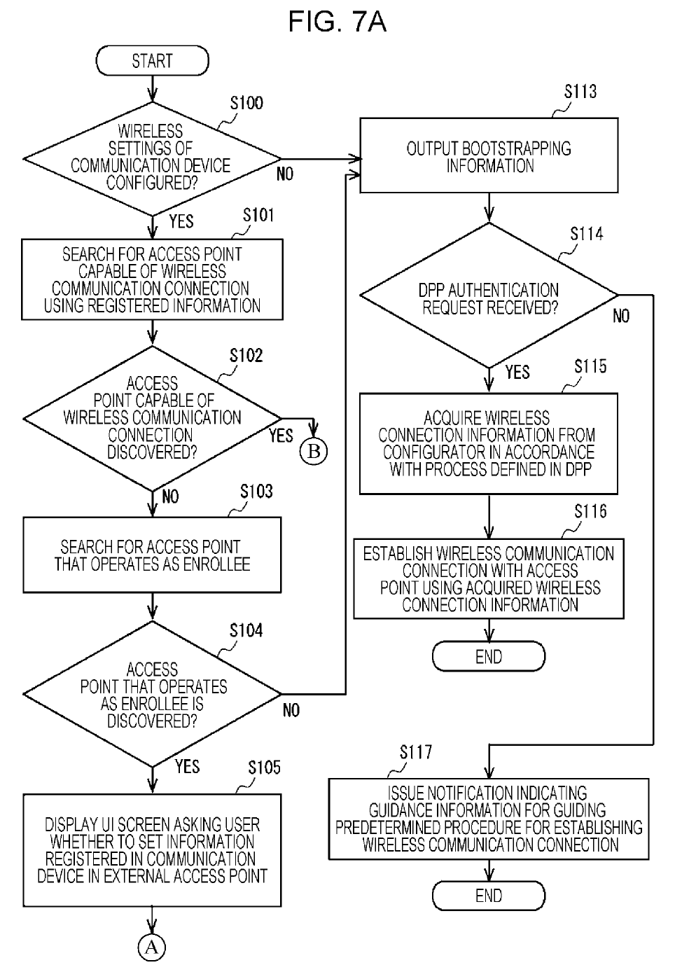

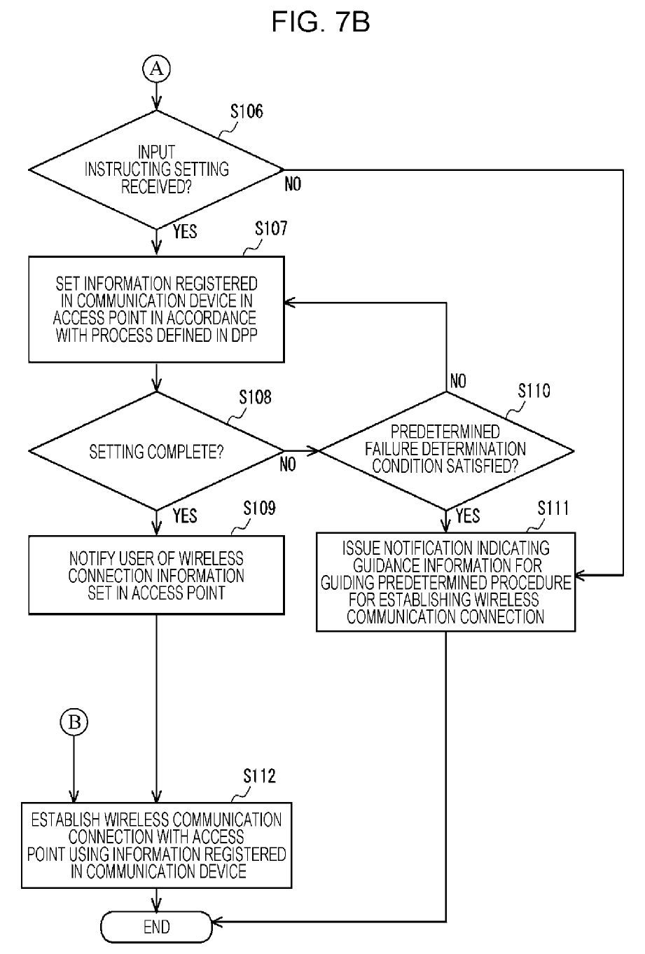

Next, a detailed operation flow of the communication device 100 according to the present embodiment will be described. FIGS. 7A and 7B are flowcharts illustrating an exemplary flow of detailed operations of the communication device 100. Hereinafter, the flow of detailed operations of the communication device 100 will be described with reference to FIGS. 7A and 7B.

In step S100, the connection processing unit 152 of the communication device 100 checks whether wireless settings of the communication device 100 have been configured. That is, the connection processing unit 152 checks whether the wireless connection information of the external access point AP1 is registered (set) in the communication device 100. If the wireless settings of the communication device 100 have been configured (YES in step S100), the process proceeds to step S101. If the wireless settings of the communication device 100 have not been configured (NO in step S100), the process proceeds to step S113.

In step S101, the connection processing unit 152 of the communication device 100 searches for an access point with which wireless communication connection can be established using the wireless connection information registered in the communication device 100. Specifically, for example, the connection processing unit 152 checks whether a beacon signal including the SSID indicated in the wireless connection information can be received. If an access point with which wireless communication connection can be established using the wireless connection information registered in the communication device 100 is discovered, that is, if the external access point AP1 capable of wireless communication connection is discovered (YES in step S102), the process proceeds to step S112. In contrast, if such an access point is not discovered, that is, if the external access point AP1 capable of wireless communication connection is not discovered (NO in step S102), the process proceeds to step S103.

In the present embodiment, when the external access point AP1 with which a wireless communication connection can be established using the wireless connection information is not discovered, the configuration processing unit 151 searches for the external access point AP2 operating as an Enrollee defined in the DPP. Therefore, as illustrated in this flowchart, when the process proceeds to step S103, the configuration processing unit 151 of the communication device 100 searches for the external access point AP2 operating as the Enrollee. Specifically, for example, the configuration processing unit 151 checks whether a bootstrap signal transmitted from the external access point AP2 via BLE communication can be received. The bootstrap signal herein is a signal including bootstrapping information. The configuration processing unit 151 may also check whether a signal called a DPP presence announcement, defined in the DPP, can be received. The DPP presence announcement signal is a signal broadcast by the Enrollee in the bootstrapping phase, and is a signal for notifying the Configurator that the process in accordance with the DPP can be performed. In the present embodiment, the wireless configuration unit 351 of the external access point AP2 starts operation as the Enrollee, that is, starts processing in the bootstrapping phase, for example, when the external access point AP2 is started or when a predetermined operation is performed by the user. That is, the wireless configuration unit 351 of the external access point AP2 starts transmitting a bootstrap signal or a presence announcement signal when the external access point AP2 is started or when a predetermined operation is performed by the user.

In the present embodiment, when the external access point AP2 operating as the Enrollee is discovered, the configuration processing unit 151 sets wireless connection information in the external access point AP2 in accordance with the process defined in the DPP. Therefore, in this flowchart, if the external access point AP2 operating as the Enrollee is discovered (YES in step S104), the process proceeds to step S105. If the external access point AP2 operating as the Enrollee is not discovered (NO in step S104), the process proceeds to step S113.

In step S105, the configuration processing unit 151 may cause the UI unit 130 (display) to display a UI screen asking the user whether to set the wireless connection information registered in the communication device 100 in the external access point AP2 discovered in step S103. This UI screen includes, for example, a message confirming whether the wireless connection information registered in the communication device 100, namely the wireless connection information of the external access point AP1, is to be set in the new external access point AP2, and a button for selecting whether to perform this processing. Then, in step S106, the configuration processing unit 151 determines whether an input instructing such setting has been received via the UI unit 130. If the user provides an instruction to set the wireless connection information already registered in the communication device 100 in the new external access point AP2 (YES in step S106), the process proceeds to step S107. In contrast, if the user does not provide such an instruction (NO in step S106), the process proceeds to step S111.

In step S107, the configuration processing unit 151 of the communication device 100 performs processing of setting, in the external access point AP2, the wireless connection information registered in the communication device 100 in accordance with the process defined in the DPP. As described above, in the present embodiment, the configuration processing unit 151 provides a user interface enabling the user to select whether to set, in the external access point AP2, wireless connection information registered in advance in the communication device 100 as information used for establishing a wireless communication connection with the external access point AP1. When instructed by the user to set the wireless connection information in the external access point AP2, the wireless connection information is set in the external access point AP2. This improves user convenience.

After step S107, in step S108, the configuration processing unit 151 checks whether the setting of the wireless connection information in the external access point AP2 has been normally completed. That is, the configuration processing unit 151 checks whether the setting has been successful. If the setting is normally complete (YES in step S108), the process proceeds to step S109. In step S109, the configuration processing unit 151 notifies the user of the result of the setting process. Specifically, the configuration processing unit 151 notifies the user of the wireless connection information set in the external access point AP2. For example, the configuration processing unit 151 causes the UI unit 130 (display) to display the wireless connection information set in the external access point AP2. As described above, when the wireless connection information registered in the communication device 100 in advance as information used for establishing a wireless communication connection with the external access point AP1 is set in the external access point AP2, the configuration processing unit 151 notifies the user of the wireless connection information set in the external access point AP2. This improves user convenience. After step S109, the process proceeds to step S112.

In contrast, if the setting is not normally complete (NO in step S108), the process proceeds to step S110. In step S110, the configuration processing unit 151 determines whether a predetermined failure determination condition is satisfied. The predetermined failure determination condition may be that the number of failures in the setting process exceeds a predetermined threshold, or may be that an elapsed time from the start of the setting process exceeds a predetermined threshold. If the predetermined failure determination condition is not satisfied (NO in step S110), the process returns to step S107 and the setting process is continued. In contrast, when the predetermined failure determination condition is satisfied (YES in step S110), the process proceeds to step S111. For example, when radio wave communication is unstable or impossible, namely, for instance, when the communication device 100 and the external access point AP2 are distant from each other, the failure determination condition may be satisfied. The reason why the failure determination condition is satisfied is not limited to the example described above.

In step S111, the configuration processing unit 151 notifies the user of guidance information describing a procedure for establishing a wireless communication connection between the communication device 100 and the external access point AP2. For example, the configuration processing unit 151 causes the UI unit 130 (display) to display the guidance information. The procedure notified by the guidance information may be a procedure according to a known wireless setting scheme. For example, the guided procedure may be a procedure according to a wireless setting scheme defined by AirStation One-Touch Secure System (AOSS (registered trademark)), a procedure according to a wireless setting scheme defined by Wi-Fi Protected Setup-Push Button Configuration (WPS-PBC), or a procedure according to a wireless setting scheme unique to the vendor of the communication device 100. These are merely examples, and the guided procedure may be another known procedure. As described above, the configuration processing unit 151 outputs the guidance information when the processing has failed to set, in the external access point AP2, the wireless connection information registered in advance in the communication device 100 as information used for establishing a wireless communication connection with the external access point AP1. That is, in this case, the configuration processing unit 151 notifies the user of information for guiding a predetermined procedure to be performed by the user for establishing a wireless communication connection between the communication device 100 and the external access point AP2. This improves user convenience.

When a predetermined failure determination condition is satisfied and the process proceeds to step S111, the configuration processing unit 151 notifies the user that the setting processing has failed and notifies the user of the guidance information described above. On the other hand, when the process has proceeded to step S111 because an instruction to execute the process of setting the wireless connection information already registered in the communication device 100 in the new external access point AP2 has not been obtained (NO in step S106), the notification of the result of the setting process is not performed.

As described above, after step S109, the process proceeds to step S112. In addition, as described above, the process also proceeds to step S112 if an access point with which a wireless communication connection can be established using the wireless connection information registered in the communication device 100 is discovered (YES in step S102). In step S112, the connection processing unit 152 of the communication device 100 establishes a wireless communication connection with an external access point using wireless connection information registered in advance in the communication device 100. When the process proceeds through step S109 to step S112, the wireless communication connection between the communication device 100 and the external access point AP2 is established in step S112. On the other hand, if YES is determined in step S102 and the process proceeds to step S112, a wireless communication connection between the communication device 100 and the external access point AP1 is established in step S112. As described above, in the present embodiment, only if the external access point AP1 with which a wireless communication connection can be discovered is not discovered (NO in step S102), the process is executed from step S103 to step S109. Otherwise (YES in step S102), a wireless communication connection between the communication device 100 and the external access point AP1 is established. As a result, the process in step S107 of setting in the external access point AP2 is less likely to be performed unnecessarily.

In this embodiment, if the wireless connection information of the external access point AP1 is not registered (set) in the communication device 100 (NO in step S100), or if the external access point AP2 does not operate as an Enrollee (NO in step S104), the process proceeds to step S113.

In step S113, as described above, the connection processing unit 152 of the communication device 100 causes the communication device 100 to operate as an Enrollee. That is, the connection processing unit 152 outputs bootstrapping information by outputting a code image or transmitting a bootstrap signal. After step S113, the process proceeds to step S114.

In step S114, the connection processing unit 152 determines whether the communication device 100 has received the DPP authentication request from the Configurator (the terminal device 200). If the DPP authentication request has been received (YES in step S114), the process proceeds to step S115. In contrast, if the DPP authentication request cannot be received (NO in step S114), the process proceeds to step S117. Specifically, for example, if a predetermined time has elapsed without receiving the DPP authentication request after step S113, the process proceeds to step S117.

In step S115, the connection processing unit 152 acquires wireless connection information from the Configurator (the terminal device 200) in accordance with the process defined in the DPP. Then, the process proceeds to step S116. In step S116, the connection processing unit 152 establishes a wireless communication connection with the external access point AP2 using the wireless connection information acquired in step S115. As described above, when the connection processing unit 152 cannot discover the external access point AP2 operating as an Enrollee defined in the DPP, the connection processing unit 152 outputs the bootstrapping information, acquires the wireless connection information from the Configurator, and establishes a wireless communication connection with the external access point AP2 using the acquired wireless connection information. This enables establishment of a wireless communication connection with the external access point AP2 even when the external access point AP2 operating as an Enrollee cannot be discovered. In addition, the connection processing unit 152 also performs the same processing when wireless connection information for establishing a wireless communication connection with the external access point AP1 is not registered in the communication device 100. That is, also in this case, the connection processing unit 152 outputs bootstrapping information, acquires the wireless connection information from the Configurator, and establishes a wireless communication connection with the external access point AP2 using the acquired wireless connection information. This enables establishment of a wireless communication connection with the external access point AP2 even when wireless connection information for establishing a wireless communication connection with the external access point AP1 is not registered in the communication device 100.

In contrast, when the process proceeds to step S117, the connection processing unit 152 notifies the user of guidance information describing a procedure for establishing a wireless communication connection between the communication device 100 and the external access point AP2. For example, the connection processing unit 152 causes the UI unit 130 (display) to display the guidance information. The procedure notified by the guidance information may be a procedure according to a known wireless setting scheme.

As described above, in the present embodiment, the communication device 100 sets the wireless connection information of the external access point AP1 included in the communication device 100 as the wireless connection information of the external access point AP2 in the external access point AP2. Then, the communication device 100 uses this wireless connection information to establish a wireless communication connection with the external access point AP2. Therefore, the user need not obtain the wireless connection information of the external access point AP2 or register the obtained wireless connection information in the communication device 100. Accordingly, a wireless communication connection can easily be established between the communication device 100 and the new external access point AP2, improving user convenience.

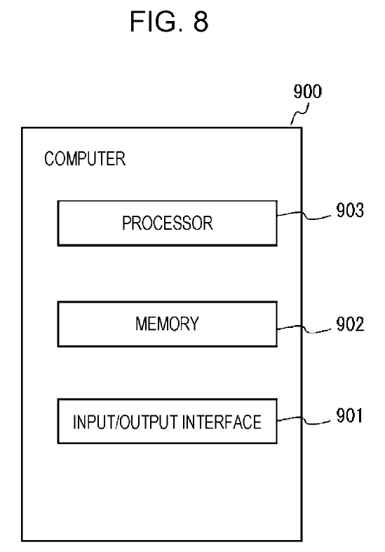

Although the embodiment has been described above, the processes of the communication device 100, the terminal device 200, and the external access points AP1 and AP2 may be executed by computers included in these devices. The computer may be implemented as a system on a chip (SoC). FIG. 8 is a block diagram illustrating an exemplary hardware configuration of a computer 900 included in the communication device 100, the terminal device 200, or the external access point AP1 or AP2. As illustrated in FIG. 8, the computer 900 includes, for example, an input/output interface 901, a memory 902, and a processor 903.

The input/output interface 901 is used for communication with any circuit or device.

The memory 902 is implemented by, for example, a combination of a volatile memory and a nonvolatile memory. The memory 902 is used for storing a program executed by the processor 903, data used for various types of processing, and the like.

The processor 903 performs various kinds of processing described in the embodiment described above by reading the program from the memory 902 and executing the program. The processor 903 may be, for example, a microprocessor, a microprocessor unit (MPU), or a central processing unit (CPU). In addition, the processor 903 may include a plurality of processors.

When read by a computer, the program includes a group of commands (or software code) for causing the computer to execute one or more functions described in the embodiment. The program may be stored in a non-transitory computer-readable medium or a solid storage medium. Non-limiting examples of the computer-readable medium or the solid storage medium include a random access memory (RAM), a read-only memory (ROM), a flash memory, a solid-state drive (SSD), and other memory technology; a CD-ROM, a Digital Versatile Disk (DVD), a Blu-ray (registered trademark) disk, or other optical disk storage; and a magnetic cassette, a magnetic tape, a magnetic disk storage, and other magnetic storage devices. The program may be transmitted on a non-transitory computer-readable medium or a communication medium. Non-limiting examples of the non-transitory computer-readable medium or the communication medium include electrical, optical, acoustic, or other forms of propagating signals.

The present disclosure is not limited to the embodiments described above and may be modified as appropriate without departing from the spirit and scope of the disclosure. For example, although in the embodiment described above the bootstrapping information is transmitted using a code image or via BLE communication, the bootstrapping information may be transmitted by another method defined in the DPP.

Some or all of the embodiments described above may also be described as, but not limited to, the following Supplementary Notes.

### Supplementary Note 1

A communication device comprising: a configuration processing unit configured to set, in a second external access point, wireless connection information registered in advance in the communication device, as information used for the communication device to establish a wireless communication connection with a first external access point; and a connection processing unit configured to establish a wireless communication connection with the second external access point using the wireless connection information.

### Supplementary Note 2

The communication device according to Supplementary Note 1, wherein when the second external access point that operates as an Enrollee defined in a device provisioning protocol (DPP) is searched for and the second external access point is discovered, the configuration processing unit is configured to set the wireless connection information in the second external access point in accordance with a process defined in the DPP.

### Supplementary Note 3

The communication device according to Supplementary Note 2, wherein when the first external access point with which a wireless communication connection is capable of being established using the wireless connection information is incapable of being discovered, the configuration processing unit is configured to search for the second external access point that operates as the Enrollee defined in the DPP.

### Supplementary Note 4

The communication device according to Supplementary Note 3, wherein when the second external access point that operates as the Enrollee defined in the DPP is incapable of being discovered, the connection processing unit is configured to: output predetermined information to be provided from the Enrollee to a Configurator in a bootstrapping phase defined in the DPP, acquire wireless connection information for establishing a wireless communication connection with the second external access point in accordance with a process defined in the DPP from a device that operates as the Configurator defined in the DPP and from which the predetermined information is acquired, and establish a wireless communication connection with the second external access point using the wireless connection information acquired from the device.

### Supplementary Note 5

The communication device according to any one of Supplementary Notes 1 to 4, wherein, when the wireless connection information for establishing a wireless communication connection with the first external access point is not registered in the communication device, the connection processing unit is configured to: output predetermined information to be provided from the Enrollee to the Configurator in the bootstrapping phase defined in the DPP, acquire, from a device operating as the Configurator defined in the DPP and having acquired the predetermined information, wireless connection information for establishing a wireless communication connection with the second external access point, in accordance with the process defined in the DPP, and establish a wireless communication connection with the second external access point using the wireless connection information acquired from the device.

### Supplementary Note 6

The communication device according to any one of Supplementary Notes 1 to 5, wherein the configuration processing unit is configured to, when the wireless connection information registered in the communication device in advance as information used for establishing a wireless communication connection with the first external access point is set in the second external access point, notify a user of the wireless connection information set in the second external access point.

### Supplementary Note 7

The communication device according to any one of Supplementary Notes 1 to 6, wherein when processing fails to set, in the second external access point, the wireless connection information registered in advance in the communication device as information used for establishing a wireless communication connection with the first external access point, the configuration processing unit is configured to notify a user of information for guiding a predetermined procedure to be followed by the user for establishing a wireless communication connection between the communication device and the second external access point.

### Supplementary Note 8

The communication device according to any one of Supplementary Notes 1 to 7, wherein the configuration processing unit is configured to: provide a user interface for selecting whether to set, in the second external access point, the wireless connection information registered in advance in the communication device as information used for establishing a wireless communication connection with the first external access point, and when instructed by a user to set the wireless connection information in the second external access point, set the wireless connection information in the second external access point.

### Supplementary Note 9

A processing method performed by a communication device, comprising: setting, in a second external access point, wireless connection information registered in advance in the communication device, as information used for the communication device to establish a wireless communication connection with a first external access point; and establishing a wireless communication connection with the second external access point using the wireless connection information.

### Supplementary Note 10

A non-transitory computer-readable storage medium storing a program, the program causing a computer of a communication device to execute a process, the process comprising: setting, in a second external access point, wireless connection information registered in advance in the communication device, as information used for the communication device to establish a wireless communication connection with a first external access point; and establishing a wireless communication connection with the second external access point using the wireless connection information.

What is claimed is:

1. A communication device comprising:
a configuration processing unit configured to set, in a second external access point, wireless connection information registered in advance in the communication device, as information used for the communication device to establish a wireless communication connection with a first external access point; and
a connection processing unit configured to establish a wireless communication connection with the second external access point using the wireless connection information.

2. The communication device according to claim 1,
wherein when the second external access point operating as an Enrollee defined in a device provisioning protocol (DPP) is searched for and the second external access point is discovered, the configuration processing unit is configured to set the wireless connection information in the second external access point in accordance with a process defined in the DPP.

3. The communication device according to claim 2,
wherein when the first external access point with which a wireless communication connection is capable of being established using the wireless connection information is incapable of being discovered, the configuration processing unit is configured to search for the second external access point operating as the Enrollee defined in the DPP.

4. The communication device according to claim 3,
wherein when the second external access point operating as the Enrollee defined in the DPP is incapable of being discovered, the connection processing unit is configured to:
output predetermined information to be provided from the Enrollee to a Configurator in a bootstrapping phase defined in the DPP,
acquire, from a device operating as the Configurator defined in the DPP and having acquired the predetermined information, wireless connection information for establishing a wireless communication connection with the second external access point, in accordance with a process defined in the DPP, and
establish a wireless communication connection with the second external access point using the wireless connection information acquired from the device.

5. The communication device according to claim 1,
wherein when the wireless connection information for establishing a wireless communication connection with the first external access point is not registered in the communication device, the connection processing unit is configured to:
output predetermined information to be provided from an Enrollee to a Configurator in a bootstrapping phase defined in a device provisioning protocol (DPP),
acquire, from a device operating as the Configurator defined in the DPP and having acquired the predetermined information, wireless connection information for establishing a wireless communication connection with the second external access point, in accordance with a process defined in the DPP, and
establish a wireless communication connection with the second external access point using the wireless connection information acquired from the device.

6. The communication device according to claim 1,
wherein the configuration processing unit is configured to, when the wireless connection information registered in the communication device in advance as information used for establishing a wireless communication connection with the first external access point is set in the second external access point, notify a user of the wireless connection information set in the second external access point.

7. The communication device according to claim 1,
wherein when processing fails to set, in the second external access point, the wireless connection information registered in advance in the communication device as information used for establishing a wireless communication connection with the first external access point, the configuration processing unit is configured to notify a user of information for guiding a predetermined procedure to be performed by the user for establishing a wireless communication connection between the communication device and the second external access point.

8. The communication device according to claim 1, wherein the configuration processing unit is configured to:
provide a user interface for selecting whether to set, in the second external access point, the wireless connection information registered in advance in the communication device as information used for establishing a wireless communication connection with the first external access point, and
when instructed by a user to set the wireless connection information in the second external access point, set the wireless connection information in the second external access point.

9. A processing method performed by a communication device, comprising:
setting, in a second external access point, wireless connection information registered in advance in the communication device, as information used for the communication device to establish a wireless communication connection with a first external access point; and
establishing a wireless communication connection with the second external access point using the wireless connection information.

10. A non-transitory computer-readable storage medium storing a program, the program causing a computer of a communication device to execute a process, the process comprising:
setting, in a second external access point, wireless connection information registered in advance in the communication device, as information used for the communication device to establish a wireless communication connection with a first external access point; and
establishing a wireless communication connection with the second external access point using the wireless connection information.
